(19) United States
(12) Patent Application Publication
(10) Pub. No.: US 2012/0020312 A1
(43) Pub. Date: Jan. 26, 2012

(54) COMMUNICATION METHOD AND NODE USED IN WIRELESS COMMUNICATION NETWORK

(75) Inventors: Chao Lv, Beijing (CN); Jun Tian, Beijing (CN); Hao Wang, Beijing (CN); Cheng Li, Beijing (CN)

(73) Assignee: Fujitsu Limited, Kawasaki (JP)

(21) Appl. No.: 13/187,636

(22) Filed: Jul. 21, 2011

(30) Foreign Application Priority Data
Jul. 22, 2010 (CN) 201010239686.1

(51) Int. Cl. H04W 72/04

(52) U.S. Cl. 370/329

(57) ABSTRACT

A wireless communication network includes a plurality of peer nodes, the plurality of nodes communicating with each other through a control channel and a plurality of data channels, the communication method including: a source node in the plurality of nodes reserves a data channel used for transmitting data to a destination node in the plurality of nodes through the control channel; the source node and the destination node switch to the reserved data channel; the source node transmits the data to the destination node through the reserved data channel; and after the data transmission between the source node and the destination node is completed, the destination node sends a data transmitting success acknowledgement signal to the source node through the reserved data channel, and then both of the destination node and the source node switch to the control channel from the reserved data channel for operation.

### CROSS REFERENCE TO RELATED APPLICATIONS

This application claims the benefit of Chinese Application No. 201010239686.1, filed Jul. 22, 2010, the disclosure of which is incorporated herein by reference.

### FIELD OF THE INVENTION

The present invention relates to wireless communication technique, particularly to a communication method used in a wireless communication network and a node used in a wireless communication network.

### BACKGROUND OF THE INVENTION

Multi-channel communication has been proved to be able to greatly improve the performance of a communication system. And in IEEE 802.11 standard, a plurality of frequency points are divided in the available frequency band for choices by the user.

In the multi-channel communication system, assignment and reservation mechanism for the channel is crucial to the improvement of the performance of the multi-channel communication system.

In the existing multi-channel assignment method, the assignment of channel is coordinated via a distributed algorithm between the nodes. This method is advantageous in that global channel utilization of network is considered, the channel utilization is high and probability of collision is small. However, it is disadvantageous in a large control information overhead and lack of robustness (in the case when a node joins in or a failure occurs, especially when a node joins in, the global network information set previously will be redistributed).

Therefore, there is still a need for an improved communication method used in wireless communication network which supports multi-channel communication, in order to reduce the control information overhead.

### SUMMARY OF THE INVENTION

A brief outline of the invention is given hereinafter to provide a basic understanding of some aspects of the invention. It should be understood that the outline is not an exhaustive one of the invention. It is not intended to define key part or important part of the invention, or limit a scope of the invention. It simply provides some concepts in a simplified form, as a preface for a more detailed description discussed later.

It is at least one object of the invention to provide a communication method used in the wireless communication network and a node used in the wireless communication network, which can at least overcome part of the disadvantages and shortcomings in the above prior arts, and reduce control information overhead while at the same time improve network performance.

In order to achieve the above object, according to one embodiment of the invention, a communication method used in a wireless communication network is provided, the wireless communication network including a plurality of peer nodes, the plurality of nodes communicating with each other through a control channel and a plurality of data channels, the communication method includes: a source node in the plurality of nodes reserves a data channel used for transmitting data to a destination node in the plurality of nodes through the control channel to the destination node; the source node and the destination node switch to the reserved data channel; the source node transmits the data to the destination node through the reserved data channel; and after the data transmission between the source node and the destination node is completed, the destination node sends a data transmitting success acknowledge signal to the source node through the reserved data channel, and then both of the destination node and the source node switch to the control channel from the reserved data channel for operation.

In order to achieve the above object, according to another embodiment of the invention, a node used in a wireless communication network is provided, the wireless communication network including a plurality of peer nodes, the plurality of nodes communicate through a control channel and a plurality of data channel, the node including: a reserving unit for reserving a data channel used for transmitting data through the control channel; a switching unit for switching to the reserved data channel; a transmitting unit for transmitting data through the reserved data channel; and a transmission acknowledgement unit for sending a data transmitting success acknowledge signal to the source node using the data channel used by the data transmission after the data is completely transmitted if the present node serving as a destination node, wherein, if the present node serving as a destination node, the switching unit switches to the control channel from the data channel after the transmission acknowledgement unit sends the data transmitting success acknowledge signal and switches to the control channel from the data channel after receiving the data transmitting success acknowledge signal from a transmission acknowledgement unit of a destination node if the present node serves as a source node.

According to the embodiment of the invention, all peer nodes operates in the control channel when there is no data transmission, and reserves the data channel to be used using the control channel when data is to be transmitted and transmits data using the reserved data channel, and switches back to the control channel when data is completely transmitted, thereby supporting multi-channel wireless communication system, ensuring small control information overhead, while at the same time ensuring system expansibility and communication performance.

These and other advantages of the invention will be more apparent through the following detailed description of the best embodiment of the invention with reference to the accompanying drawings.

### BRIEF DESCRIPTION OF THE DRAWINGS

The invention may be better understood with reference to the following description given in connection with the accompanying drawings, in which, the same or similar reference numerals are used to represent same or similar parts. All the accompanying drawings together with the following detailed description are included in the specification and form a part of the specification, and are further used to exemplify the preferable embodiments of the invention and explain the principle and advantages of the invention. In the accompanying drawings:

FIG. 1 illustrates a schematic view of a communication method used in a wireless communication network according to the first embodiment of the invention;

FIG. 2 illustrates a schematic view of a communication method used in a wireless communication network according to the second embodiment of the invention;

FIG. 3 illustrates a schematic view of a frame format of RTS and CTS in prior art;

FIG. 4 illustrates a schematic view of MRTS/MCTS frame format on a multi-channel basis used in a communication method used in a wireless communication network according to the embodiment of the invention;

FIG. 5 illustrates a schematic view of MRTS/MCTS frame transmission process on a multi-channel basis used in a communication method used in a wireless communication network according to the embodiment of the invention;

FIG. 6 illustrates a schematic view of switching between a control channel and a data channel in the communication method used in a wireless communication network according to the embodiment of the invention;

FIG. 7 illustrates a schematic view of a format of a data channel identification field in the MRTS frame used in a communication method used in a wireless communication network according to the embodiment of the invention;

FIG. 8 illustrates a schematic view of a communication method used in a wireless communication network according to the third embodiment of the invention;

FIG. 9 illustrates a schematic view of switching between a control channel and a data channel in a communication method used in a wireless communication network according to the third embodiment of the invention;

FIG. 10 illustrates another schematic view of switching between a control channel and a data channel in a communication method used in a wireless communication network according to the third embodiment of the invention;

FIG. 11 illustrates a schematic view of a preamble queue;

FIG. 12 illustrates a schematic view of a node used in a wireless communication network according to the fourth embodiment of the invention; and

FIG. 13 illustrates a schematic view of a node used in a wireless communication network according to the fifth embodiment of the invention.

Those skilled in the art should understand that elements in the accompanying drawings are shown merely for simplicity and clarity, and may not necessarily drawn in scale. For example, some elements in the drawings may be enlarged in size as compared with other elements to facilitate understanding of the embodiment of the invention.

### DETAILED DESCRIPTION OF THE INVENTION

The illustrative embodiment of the invention will be described in detail in connection with the accompanying drawings in the following. For clarity and simplicity, not all features of the actual embodiments are described in the description. However, it should be understood that many decisions specific to the embodiments must be made in the process of developing any such actual embodiments to achieve a specific object of the developers, such as compliance with those restrictions related with system and business, which may change according to different embodiments. Furthermore, it should be understood that although the developing work may be very complex and time consuming, for those skilled in the art benefiting from the disclosure of the invention, such developing work is merely a routine task.

Here, it should also be noted that in order to avoid the invention from being blurred by unnecessary details, in the accompanying drawings and description, only device structures and/or processing steps closely related to the scheme according to the invention are described, and the representation and description for the part and processing those skilled in the art already know, which also haven't much thing to do with the invention, are omitted.

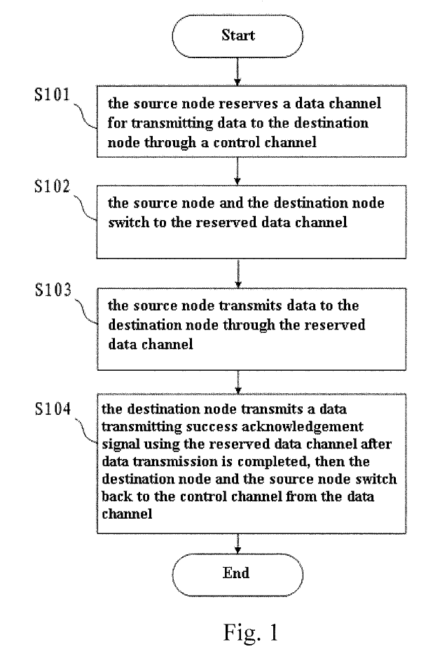

FIG. 1 illustrates a schematic view of a communication method used in a wireless communication network according to the first embodiment of the invention. The wireless communication network includes a plurality of peer nodes, which communicates with each other through a control channel and a plurality of data channels.

As shown in FIG. 1, the communication method used in the wireless communication network according to the first embodiment of the invention starts from step S101.

In step S101, a source node in the plurality of nodes reserves a data channel used for transmitting data to a destination node in the plurality of nodes through the control channel.

In step S102, both the source node and the destination node switch to the reserved data channel.

In step S103, the source node transmits the data to the destination node through the reserved data channel.

In step S104, after the data transmission is completed between the source node and the destination node, the destination node sends a data transmitting success acknowledge signal to the source node through the reserved data channel, and then both of the destination node and the source node switch to the control channel from the reserved data channel for operation.

From the above, according to the communication method used in the wireless communication network of the embodiment of the invention, all peer nodes operate in the control channel when there is no data transmission, and reserves the data channel to be used using the control channel when data is to be transmitted and transmits data using the reserved data channel, and switches back to the control channel for operation when data transmission is completed, thereby supporting multi-channel wireless communication system, ensuring small control information overhead, while at the same time ensuring system expansibility and communication performances.

In addition, it needs to be noted that although the communication method used in the wireless communication network according to the embodiment of the invention is described with reference to the schematic view shown in FIG. 1, those skilled in that art should understand that the schematic view shown in FIG. 1 is merely illustrative, but not a restriction on the scope of the invention. Those skilled in the art may modify the schematic view shown in FIG. 1 according to practical needs. For example, those skilled in the art may flexibly set a format of a signal of the reserved data channel and data transmitting success acknowledgement signal based on requirements by performances and functions of practical wireless communication system.

It also needs to be noted that the steps executing the above mentioned series of process may be executed chronologically in the specified order, but not necessarily in time sequence. Some steps may be executed in parallel with or independently from each other.

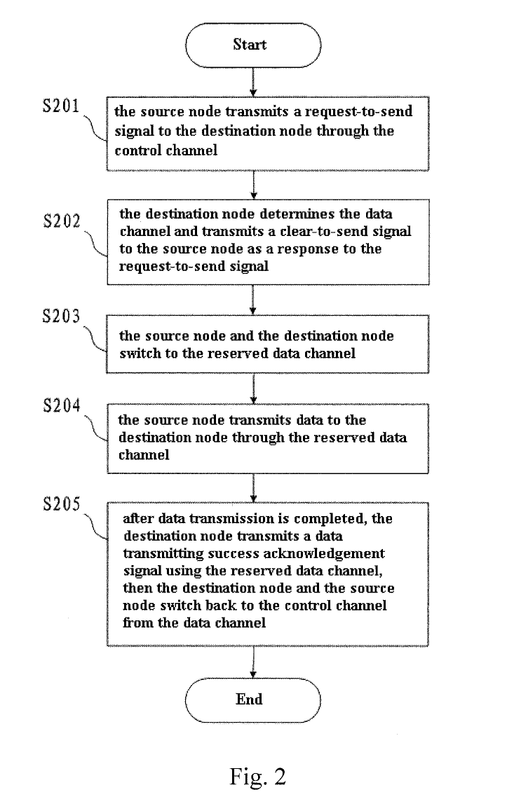

FIG. 2 illustrates a schematic view of a communication method used in a wireless communication network according to the second embodiment of the invention. The wireless communication network includes a plurality of peer nodes, the plurality of peer nodes communicating with each other through a control channel and a plurality of data channels.

The embodiment is an extension of existing RTS/CTS handshaking mechanism supporting single channel, in order to support multi-channel wireless communication network. Hereinafter the existing RTS/CTS handshaking mechanism is briefly introduced first.

RTS/CTS (Request To Send/Clear To Send) handshaking mechanism is a request to send/clear to send handshaking mechanism, mainly for solving the problem of “Hidden Stations”. “Hidden Stations” refers to a case in which node A sends a signal to node B, and node C doesn't detect that node A also sends the signal to node B, so node A and node C simultaneously send the signal to node B, leading to signal collision, and at last a loss of the all the signals sent to node B. This case leads to efficiency loss, and needs an error recovery mechanism. When a large number of documents need to be transmitted, the phenomenon of “Hidden stations” especially needs to be eliminated.

IEEE 802.11 protocol provides the following solution. In parameter configuration, RTS/CTS enables threshold to be set. Once the length of the data to be transmitted is larger than this threshold, RTS/CTS handshaking protocol is started. First, A transmits RTS signal to B, indicating that A is going to transmit several data to B. Upon receiving RTS, B replies CTS signal to A, indicating that B is ready. A may transmit data to B, and other nodes receiving CTS signal enters into retreat status, until the communication between A and B is completed. The actual data transmission is started only after both parties successfully exchanges RTS/CTS signal (i.e. handshaking completed), ensuring that in a case a plurality of transmitting nodes invisible to each other transmit signal to the same receiving node, actually only the node receiving CTS replied by the receiving node can transmit signal, thereby avoiding collision. Even if a collision occurs, it occurs only during transmitting RTS. In such circumstance, since CTS message from the receiving node can not be received, various transmitting nodes use a competition mechanism provided by DCF, retreat according to a predetermined time period, and compete to transmit RTS after the medium is idle for DIFS next time, until success.

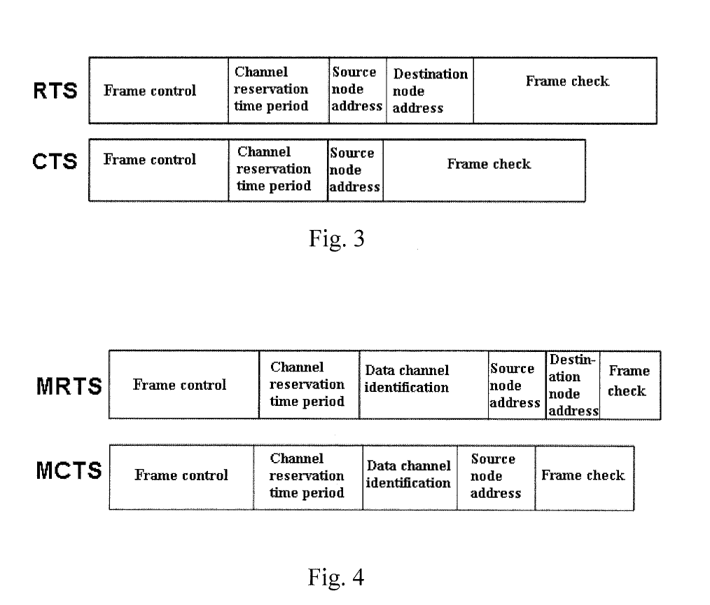

The frame format of existing RTS and CTS is shown in FIG. 3. The time period defined by the channel reservation time period field is used for the node receiving CTS signal to retreat according to the time period, in order to avoid collision.

The frame format of existing RTS/CTS only supports a communication network of single channel, and reduces channel collision by CSMA/CA (Carrier Sense Multiple Access/Collision Avoidance) mechanism. It also can be seen from the frame format shown in FIG. 3 that the existing RTS/CTS signal only reserves an occupied time period of single channel.

Now back to FIG. 2. As shown in FIG. 2, the communication used in a wireless communication network according to the embodiment starts from step S201.

In step S201, the source node among a plurality of nodes sends a request-to-send signal (also referred to as MRTS (Multi-channel RTS) signal) to the destination node through the control channel, the request-to-send signal including a first indication information for indicating available data channel(s) of the source node and information indicating the destination node.

In one example, the first indication information may include: identification(s) of the available data channel(s) in a priority order; or identification(s) of the available data channel(s) and respective priority index value(s).

Those skilled in the art should understand that the content of the above mentioned first indication information is merely illustrative. Those skilled in the art may flexibly set the content included in the first indication information according to application requirements by the actual wireless communication network, which shall be within the spirit and scope of the invention. For example, the first indication information may be set to only include the number of available data channel.

Then, in step S202, the destination node receives the request-to-send signal, determines the reserved data channel according to the first indication information and information relating to available data channel(s) of the destination node maintained by the destination node, and sends a clear-to-send signal (referred to as MCTS (Multi-channel CTS) signal) to the source node, the clear-to-send signal including a second indication information for indicating the reserved data channel and information indicating the source node.

In one example, the information relating to available data channel(s) of the destination node may include identification(s) of the available data channel(s) of the destination node and respective priority index value(s).

Those skilled in the art should understand that the content included in information relating to the available data channel of the destination node is merely illustrative. Those skilled in the art may flexibly set the content of the information according to the application requirements by the actual wireless communication network, which shall be within the spirit and scope of the invention.

For example, FIG. 4 shows an illustrative schematic view of frame format of MRTS/MCTS on a multi-channel basis used in a communication method used in a wireless communication network according to the embodiment of the invention.

As shown in FIG. 4, as compared with the existing frame format of RTS/CTS shown in FIG. 3, in MRTS/MCTS frame used in the embodiment, a data channel identification field is added after the channel reservation time period field to identify the data channel to be reserved, and support multi-channel wireless communication network. Specifically, for MRTS/MCTS frame, in the data channel identification field therein, the above mentioned first indication information indicating the available data channel of the source node is included, and in the frame control field therein, the above mentioned information indicating the destination node is included. For MCTS frame, in the data channel identification field therein, the above mentioned second indication information indicating the reserved data channel is included, and in the frame control field therein, the above mentioned information indicating the source node is included.

Those skilled in the art should understand that FIG. 4 is merely an illustrative frame format. Those skilled in the art may flexibly set position of the data channel identification field in MRTS/MCTS and respective field length according to requirements by actual application, which shall be within the spirit and scope of the invention.

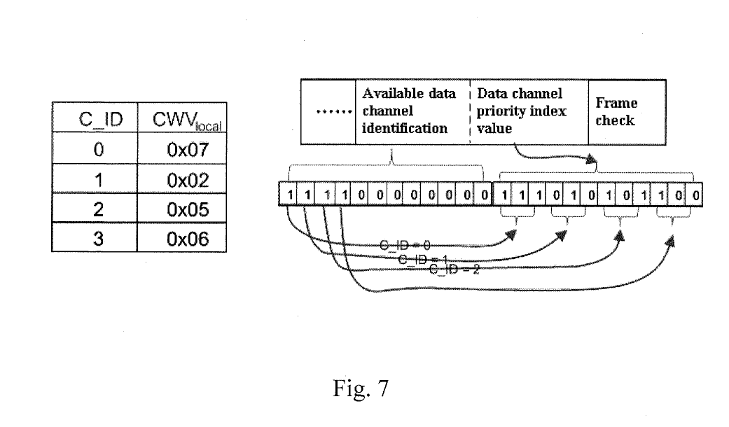

Further, for example, FIG. 7 shows an illustrative schematic view of format of the data channel identification field in MRTS frame used in the communication method used in the wireless communication network according to the embodiment of the invention.

As shown in left side of FIG. 7, C_ID indicates identification of various available data channels, CWV_{local} indicates priority index values corresponding to various available data channels.

As shown in right side of FIG. 7, data channel identification field is set to be 3 bytes, the former 1.5 bytes indicates an identification of available data channel, the latter 1.5 bytes indicates priority index value corresponding to available data channel. As shown in FIG. 7, the identifications of available data channel are 0-3, and corresponding priority index values are 7, 2, 5, 6, respectively.

Thus, upon receiving MRTS frame including the data channel identification field set as above sent from the source node, the destination node determines the reserved data channel according to the available data channel indicated in the data channel identification field and respective priority index value and information relating to available data channel(s) of the destination node maintained by the destination node, and sends a MCTS frame to the source node as a reply. The MCTS frame includes a second indication information for indicating the reserved data channel and information indicating the source node.

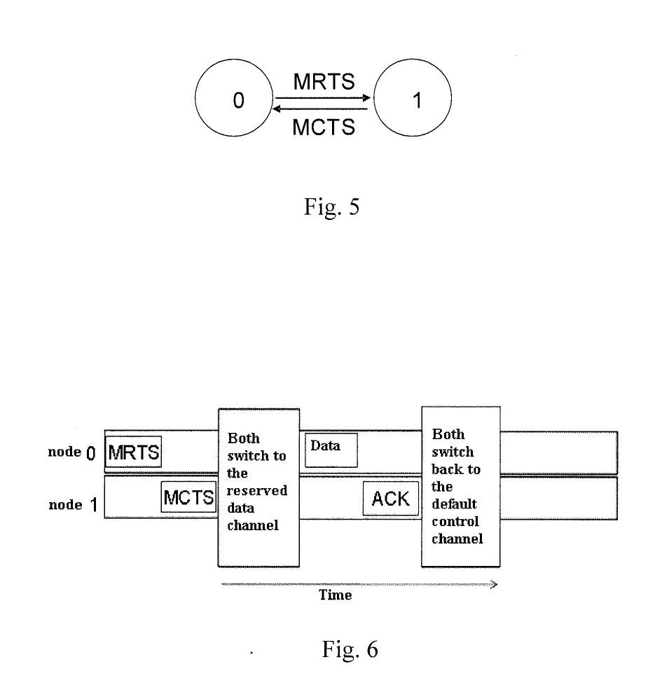

Further, for example, FIG. 5 shows a schematic view of MRTS/MCTS frame transmission process on a multi-channel basis used in a communication method used in a wireless communication network according to the embodiment of the invention.

As shown in FIG. 5, node 0 which is the source node transmits a request-to-send signal (MRTS frame) to node 1 which is the destination node. Node 1 which is the destination node receives the MRTS frame, determines the reserved data channel according to the first indication information included in the MRTS frame and information relating to the available data channel of node 1 maintained by node 1, and transmits a clear-to-send signal (MCTS frame) to node 0 as a reply. The MCTS frame includes a second indication information for indicating the reserved data channel and information for indicating node 0.

Now back to FIG. 2. Subsequently, in step S203, the source node and the destination node switch to the reserved data channel.

In one example, step S203 may include: the destination node switches to the reserved data channel within a predetermined guard period after sending the clear-to-send signal, and the source node switches to the reserved data channel within the guard period after receiving the clear-to-send signal.

Those skilled in the art should understand that the above mentioned switch process is merely illustrative. Those skilled in the art may flexibly set the switch process between the source node and the destination node according to application requirements by the actual wireless communication network, which shall be within the spirit and scope of the invention.

Then, in step S204, the source node transmits data to the destination node via the reserved data channel.

At last, in step S205, after data transmission between the source node and the destination node is completed, the destination node transmits a data transmitting success acknowledge signal to the source node using the reserved data channel, and the destination node and the source node both switch to the control channel from the reserved data channel for operation.

FIG. 6 further illustrates a schematic view of switching between the control channel and the data channel in a communication method used in a wireless communication network according to the embodiment of the invention.

As shown in FIG. 6, node 0 which is the source node transmits MRTS frame to node 1 which is the destination node to request data transmission. Node 1 which is the destination node transmits MCTS frame as a reply to node 0 which is the source node. Then node 0 and node 1 both switch to the data channel reserved by MRTS frame and MCTS frame to transmit data between the two. When data transmission is completed after a period of time, the destination node transmits a data transmitting success acknowledge signal (ACK) to the source node by using the reserved data channel. Then the destination node and the source node both switch to the default control channel from the reserved data channel for operation.

Further, in one example, the following step may be included after step S205: updating the information relating to available data channel(s) of the destination node according to data channel quality of the destination node and data channel quality of a neighbor node of the destination node.

It can be known from the above that according to the communication method used in the wireless communication network of the second embodiment of the invention, by reservation of data channel between the source node and the destination node based on modified MRTS/MCTS frame, multi-channel communication can be effectively supported by simple modification of existing protocol, leading to a small control information overhead and convenient operation, while at the same time ensuring system expansibility and communication performance.

Furthermore, it should be noted that although the communication method used in a wireless communication network according to the second embodiment is described with reference to the schematic views shown in FIG. 2 and FIGS. 4-7, those skilled in the art should understand that the schematic views in FIG. 2 and FIGS. 4-7 are merely illustrative, and not a restriction on the scope of the invention. Those skilled in the art may modify the schematic views shown in FIG. 2 and FIGS. 4-7 according to practical needs.

It also needs to be noted that the steps executing the above mentioned series of processes may be executed chronologically in the specified order, but not necessarily executed in time sequence. Some steps may be executed in parallel with or independently from each other

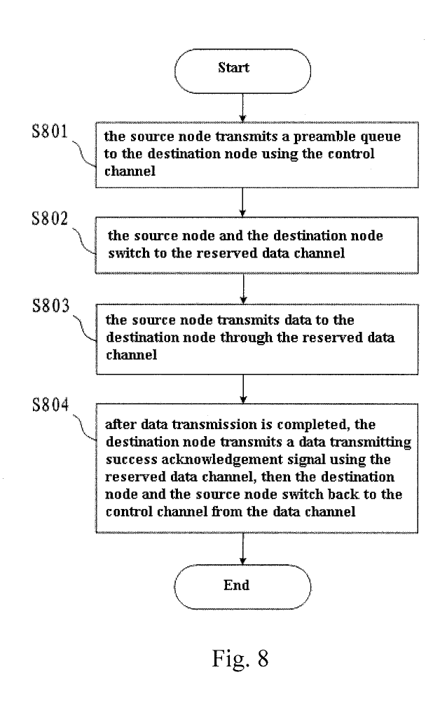

FIG. 8 shows a schematic view of a communication method used in a wireless communication network according to a third embodiment of the invention. The wireless communication network includes a plurality of peer nodes communicating with each through a control channel and a plurality of data channels.

As shown in FIG. 8, the communication method used in the wireless communication network according to the third embodiment of the invention starts from step S801.

First, in step S801, the source node among a plurality of nodes sends a preamble queue to the destination node among a plurality of nodes through the control channel, the preamble queue including information indicating a data channel reserved by the source node and information indicating the destination node.

Then, in step S802, the source node and the destination node switch to the reserved data channel.

In one example, step S802 may include: the source node switches from the control channel to the data channel reserved by the source node within a predetermined guard period after sending the preamble queue, and the destination node switches from the control channel to the data channel reserved by the source node within the predetermined guard period after receiving the preamble queue.

Those skilled in the art should understand that the above switch process is merely illustrative. Those skilled in the art may flexibly set the switch process between the source node and the destination node according to the application requirements by the actual wireless communication network, which shall be within the spirit and scope of the invention.

Subsequently, in step S803, the source node transmits data to the destination node through the reserved data channel.

At last, in step S804, after data transmission between the source node and the destination node is completed, the destination node transmits a data transmitting success acknowledgement signal (ACK) using the reserved data channel, and then the destination node and the source node both switch from the reserved data channel to the control channel for operation.

For example, FIG. 9 shows a schematic view of switching between the control channel and the data channel in a communication method used in a wireless communication network according to the third embodiment of the invention.

As shown in FIG. 9, node 0 which is the source node transmits a preamble queue to node 1 which is the destination node, then node 0 and node 1 both switch to the data channel reserved by the preamble queue in a guard period to transmit data between the two. When data transmission is completed after a period of time, the destination node transmits a data transmitting success acknowledge signal (ACK) to the source node by using the reserved data channel. Then the destination node and the source node both switch to the default control channel from the reserved data channel for operation.

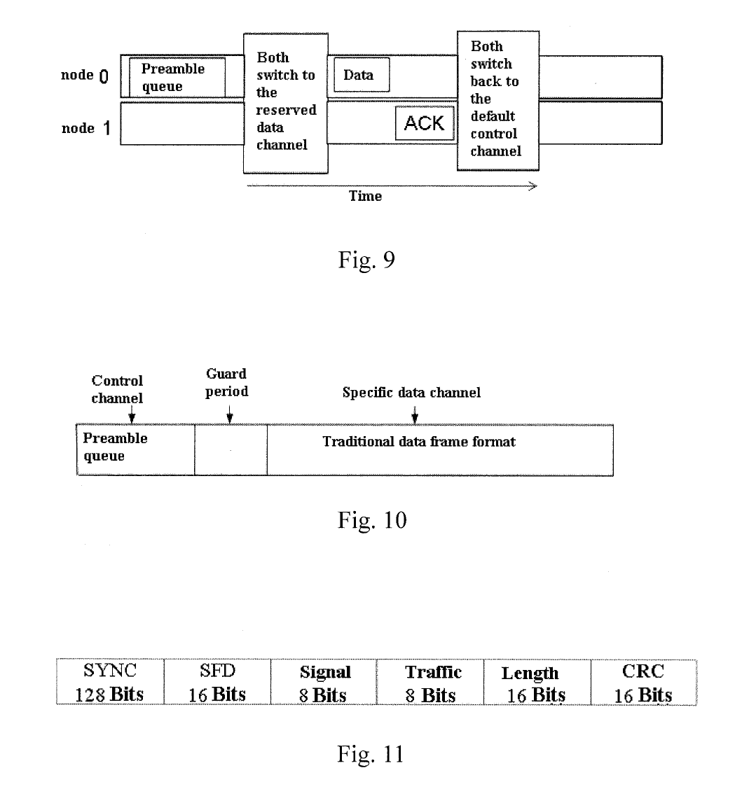

Further, for example, FIG. 10 shows another schematic view of switching between the control channel and data channel in a communication method used in a wireless communication network according to the third embodiment of the invention.

As shown in FIG. 10, first, the source node and the destination node both operate in a control channel. The source node transmits a preamble queue to the destination node through a control channel. Then, the source node and the destination node both switch to the data channel reserved by the preamble queue in a guard period. Subsequently, after the guard period, the source node and the destination node execute data transmission between them through the reserved specific data channel.

Further, for example, FIG. 11 shows a schematic view of a preamble queue.

FIG. 11 is a schematic view of a format of a preamble queue used in prior art. Those skilled in the art should understand that the position and length of the field indicating information of the reserved data channel can be set flexibly in the preamble queue according to application requirements for the actual wireless communication network, which shall be within the spirit and scope of the invention.

It can be seen from the above that according to the communication method used in a wireless communication network of the third embodiment, by reservation of data channel between the source node and the destination node based on modified preamble queue, multi-channel communication can be effectively supported by simple modification of existing preamble queue, leading to a small control information overhead and convenient operation, while at the same time ensuring system expansibility and communication performance.

Further, is should be noted that although the communication method used in a wireless communication network according to the third embodiment is described with reference to schematic views shown in FIGS. 8-11, those skilled in the art should understand that the schematic views shown in FIGS. 8-11 are merely illustrative, and not a restriction on the scope of the invention. Those skilled in the art may modify the schematic views shown in FIGS. 8-11 according to actual needs.

It also needs to be noted that the steps executing the above mentioned series of process may be executed chronologically in the specified order, but not necessarily in time sequence. Some steps may be executed in parallel with or independently from each other.

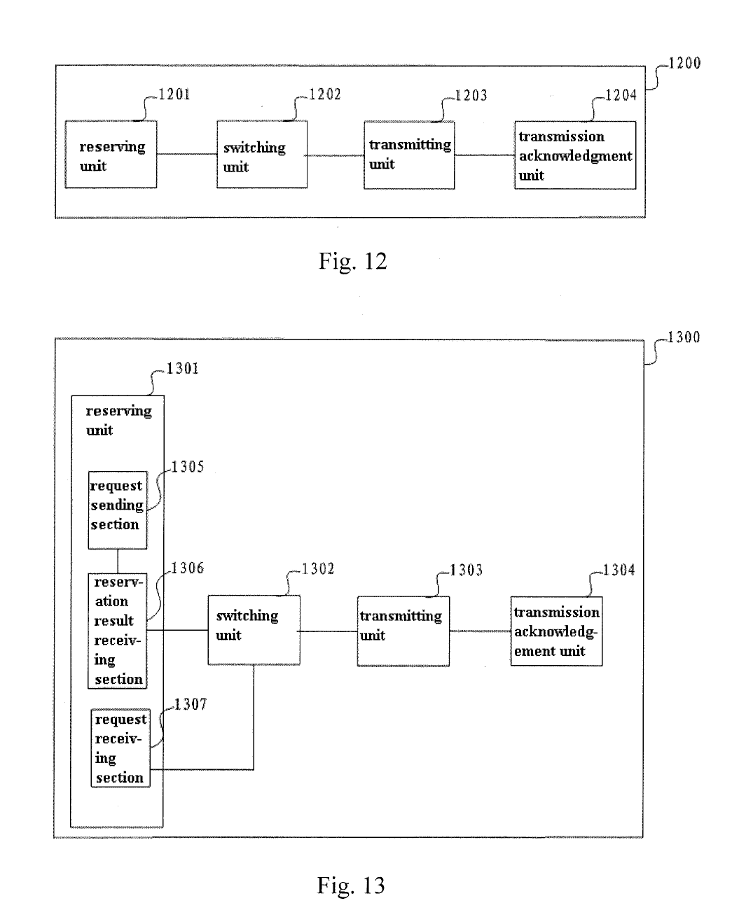

The communication method used in a wireless communication network according to the first to the third embodiments of the invention, for example, may be implemented by the node used in a wireless communication network of FIGS. 12-13.

FIG. 12 shows a schematic view of a node used in a wireless communication network according to the fourth embodiment of the invention. The wireless communication network includes a plurality of peer nodes, the plurality of peer nodes communicating with each through a control channel and a plurality of data channels.

As shown in FIG. 12, the node used in a wireless communication network according to the fourth embodiment of the invention includes a reserving unit 1201, a switching unit 1202, a transmitting unit 1203 and a transmission acknowledgement unit 1204.

The reserving unit 1201 is configured for reserving, through the control channel, a data channel used for transmitting data.

The switching unit 1202 is configured for switching to the reserved data channel.

The transmitting unit 1203 is configured for transmitting data through the reserved data channel.

The transmission acknowledgement unit 1204 is configured for sending a data transmitting success acknowledge signal to the source node through the data channel used by the data transmission after the data is completely transmitted if the present node serves as a destination node.

Wherein, if the present node serves as the destination node, the switching unit 1202 switches back to the control channel from the data channel after the transmission acknowledgement unit 1204 sends the data transmitting success acknowledge signal and switches back to the control channel from the data channel after receiving the data transmitting success acknowledge signal transmitted from a transmission acknowledgement unit 1204 of a destination node if the present node serves as the source node.

It can be seen from the above that the node used in a wireless communication network according to the fourth embodiment operates in the control channel when there is no data transmission, and reserves, using the control channel, the data channel to be used when data is to be transmitted and transmits data using the reserved data channel, and switches back to the control channel for operation when data transmission is completed, thereby greatly reducing control information overhead, while at the same time supporting multi-data channel wireless communication system.

FIG. 13 shows a schematic view of a node used in a wireless communication network according to a fifth embodiment of the invention. The wireless communication network includes a plurality of peer nodes, the plurality of peer nodes communicate with each other through a control channel and a plurality of data channels.

As shown in FIG. 13, the node used in a wireless communication network according to the fifth embodiment of the invention includes a reserving unit 1301, a switching unit 1302, a transmitting unit 1303 and a transmission acknowledgement unit 1304.

The reserving unit 1301 is configured for reserving, through a control channel, a data channel for transmitting data.

As shown in FIG. 13, the reserving unit 1301 includes: a request sending section 1305 for, if the present node serves as a source node, sending a request-to-send signal to a destination node, the request-to-send signal including a first indication information for indicating available data channel(s) of the source node and information indicating the destination node; a request receiving section 1306 for, if the present node serves as a destination node, receiving a request-to-send signal sent by a reservation request sending section of a source node, determining the reserved data channel according to first indicating information of the source node and information relating to available data channel(s) of the destination node maintained by the destination node, and sending a clear-to-send signal to the source node, the clear-to-send signal including a second indication information for indicating the reserved data channel and information indicating the source node; and a reservation result receiving section 1307 for, if the present node serves as a source node, receiving a clear-to-send signal sent by the request receiving section of a destination node.

The switching unit 1302 is configured for switching to the reserved data channel.

The transmission unit 1303 is configured for transmitting data through the reserved data channel.

The transmission acknowledgement unit 1304 is configured for, if the present node is a destination node, transmitting a data transmitting success acknowledgement signal to the source node using the data channel used by data transmission after data transmission is completed.

Wherein, if the present node is a destination node, the switching unit 1302 switches from the data channel to the control channel after the transmission acknowledgement unit 1304 transmits a data transmitting success acknowledgment signal, and switches from the data channel to the control channel upon receiving the data transmitting success acknowledgement signal sent by the transmission acknowledgment unit 1304 of the destination node if the present node serves as the source node.

It can be seen from the above that the node used in a wireless communication network according to the fifth embodiment reserves a data channel between nodes based on modified MRTS/MCTS frame, thereby effectively supporting multi-channel communication by simple modification of existing protocol, leading to a small control information overhead and convenient operation, while at the same time ensuring system expansibility and communication performance.

Further, in one example, the switching unit 1302 may further be used for switching to the reserved data channel within a predetermined guard period after transmitting clear-to-send signal or receiving clear-to-send signal.

Further, in one example, the first indication information may include: identification(s) of the available data channel(s) in a priority order; or identification(s) of the available data channel(s) and respective priority index value(s).

Further, in one example, the information relating to available data channel(s) of the destination node may include identification(s) of the available data channel(s) of the destination node and respective priority index value(s).

Further, in one example, the reserving unit 1301 may further include an updating section for updating the information relating to available data channel(s) of the node according to data channel quality of the node and data channel quality of a neighbor node of the node.

In addition, in one example, if the present node serves as a source node, the reserving unit 1301 may further be used for sending a preamble queue through the control channel, the preamble queue including information indicating a data channel reserved by the source node and information indicating the destination node. Further, if the present node serves as a source node, the switching unit 1302 may switch from the control channel to the reserved data channel within a predetermined guard period after the reserving unit 1301 sends the preamble queue and if the present node serves as a destination node, the switching node switches from the control channel to the reserved data channel within the predetermined guard period after receiving the preamble queue sent from a reserving unit 1301 of the source node.

It can be seen from the above that the node used in a wireless communication network according to the example reserves the data channel between nodes based on the modified preamble queue, thereby effectively supporting multi-channel communication by simple modification of the existing preamble queue, leading to a small control information overhead and convenient operation, while at the same time ensuring system expansibility and communication performance.

By reading the above described operation process of the communication method used in the wireless communication network according to the embodiment of the invention, it becomes very clear how to realize the function of above described various components of the node used in the wireless communication network shown in FIG. 12 and FIG. 13. Therefore, for simplicity, it will not be described in detail how to realize the function of above described various components.

In addition, it needs to be noted that although the device constructing the index library according to the embodiment is described with reference to schematic views shown in FIG. 12 and FIG. 13, those skilled in that art should understand that the schematic views shown in FIG. 12 and FIG. 13 are merely illustrative, but not a restriction on the scope of the invention. Those skilled in the art may change or modify the schematic views shown in FIG. 12 and FIG. 13 according to practical needs.

According to the embodiment of the invention, a wireless communication network including the node used in a wireless communication network according to the invention is also provided.

Although the invention and its advantage are described in detail, it should be understood that various changes, substitutions and replacements may be made without departing from the spirit and scope of the invention defined by the claims.

At last, it should be noted that in the description, relational terminology such as the first and the second is merely used to differentiate one entity or operation from another entity or operation, without requiring or implying any such practical relation or order between those entities or operations. Moreover, terms “include”, “comprise” or any other varieties thereof are intended to encompass non-exclusive containment. Therefore, process, method, article or device including a series of elements not only include those elements, but also include other elements not listed specifically, or elements inherent in the process, method, article or device. With no more restrictions, elements defined by sentence “including one . . . ” do not exclude other same elements in the process, method, article or device including said elements.

Although the embodiment of the invention has been described in detail with reference to the accompanying drawings, it should be noted that the above described embodiments are merely used to illustrate the invention, without restricting the invention. For those skilled in the art, various modifications and alterations may be made without departing from the spirit and scope of the invention. Therefore, the scope of the invention is merely defined by the claims and its equivalents.

1. A communication method used in a wireless communication network, the wireless communication network comprising a plurality of peer nodes, the plurality of nodes communicate with each other through a control channel and a plurality of data channels, the communication method comprising:
a source node in the plurality of nodes reserves a data channel used for transmitting data to a destination node in the plurality of nodes through the control channel;
the source node and the destination node switch to the reserved data channel;
the source node transmits the data to the destination node through the reserved data channel; and
after the data is completely transmitted to the destination node, the destination node sends a data transmitting success acknowledge signal to the source node through the reserved data channel, and then both of the destination node and the source node switch to the control channel.

2. The communication method of claim 1, wherein the reserving comprises:
the source node sends a request-to-send signal to the destination node, the request-to-send signal comprising a first indication information for indicating available data channel of the source node and information indicating the destination node; and
the destination node receives the request-to-send signal, determines the reserved data channel according to the first indicating information and information relating to available data channel of the destination node maintained by the destination node, and sends a clear-to-send signal to the source node, the clear-to-send signal comprising a second indication information for indicating the reserved data channel and information indicating the source node.

3. The communication method of claim 2, wherein the switching comprises:
the destination node switches to the reserved data channel within a predetermined guard period after sending the clear-to-send signal, and the source node switches to the reserved data channel within the predetermined guard period after receiving the clear-to-send signal.

4. The communication method of claim 2, wherein the first indication information comprises:
an identification of the available data channel in a priority order; or
an identification of the available data channel and respective priority index value.

5. The communication of claim 2, wherein the information relating to available data channel of the destination node comprises an identification of the available data channel of the destination node and respective priority index value.

6. The communication method of claim 2, further comprising updating the information relating to available data channel of the destination node according to data channel quality of the destination node and data channel quality of a neighbor node of the destination node.

7. The communication method of claim 1, wherein the reserving comprises: the source node sends a preamble queue to the destination node through the control channel, the preamble queue comprising information indicating a reserved data channel of the source node and information indicating the destination node.

8. The communication method of claim 7, wherein the switching comprises: the source node switches from the control channel to the reserved data channel within a predetermined guard period after sending the preamble queue, and the destination node switches from the control channel to the reserved data channel within the predetermined guard period after receiving the preamble queue.

9. A node used in a wireless communication network, the wireless communication network comprising a plurality of peer nodes, the plurality of nodes communicate through a control channel and a plurality of data channel, the node comprising:
a reserving unit for reserving a data channel used for transmitting data through the control channel;
a switching unit for switching to the reserved data channel;
a transmitting unit for transmitting data through the reserved data channel; and
a transmission acknowledgement unit for sending a data transmitting success acknowledge signal through the reserved data channel after the data is completely transmitted if the present node serving as a destination node,
wherein, if the present node serving as a source node, the switching unit switches to the control channel after the transmission acknowledgement unit sends the data transmitting success acknowledge signal if the node serving as a destination node and switches to the control channel after receiving the data transmitting success acknowledge signal from a transmission acknowledgement unit of a destination node.

10. The node of claim 9, wherein the reserving unit comprising:
a request sending section for, if the present node serving as a source node, sending a request-to-send signal to a destination node, the request-to-send signal comprising a first indication information for indicating available data channel(s) of the source node and information indicating the destination node;
a request receiving section for, if the present node serving as a destination node, receiving a request-to-send signal sent by a request sending section of a source node, determining the reserved data channel according to first indicating information of the source node and information relating to available data channel(s) of the destination node maintained by the destination node, and sending a clear-to-send signal to the source node, the clear-to-send signal comprising a second indication information for indicating the reserved data channel and information indicating the source node; and
a reservation result receiving section for, if the present node serving as a source node, receiving a clear-to-send signal sent by the request receiving section of a destination node.

11. The node of claim 10, wherein the switching unit switches to the reserved data channel within a predetermined guard period after sending the clear-to-send signal or after receiving the clear-to-send signal.

12. The node of claim 10, wherein the first indication information comprises:
an identification of the available data channel in a priority order; or
an identification of the available data channel and respective priority index value.

13. The communication of claim 10, wherein the information relating to available data channel of the destination node comprises an identification of the available data channel of the destination node and respective priority index value.

14. The node of claim 10, wherein the reserving unit further comprises an updating section for updating the information relating to available data channel of the present node according to data channel quality of the present node and data channel quality of a neighbor node of the present node.

15. The node of claim 9, wherein if the present node serves as a source node, the reserving unit sends a preamble queue to a destination node through the control channel, the preamble queue comprising information indicating a reserved data channel of the source node and information indicating the destination node.

16. The node of claim 15, wherein if the present node serves as a source node, the switching unit switches from the control channel to the reserved data channel within a predetermined guard period after the reserving unit sending the preamble queue and if the present node serves as a destination node, the switching node switches from the control channel to the reserved data channel within the predetermined guard period after receiving the preamble queue from a reserving unit of the source node.
